(19) United States
(12) Patent Application Publication
(10) Pub. No.: US 2026/0019718 A1
(43) Pub. Date: Jan. 15, 2026

(54) MULTI-CAMERA SYSTEM

(71) Applicant: Meta Platforms Technologies, LLC, Menlo Park, CA (US)

(72) Inventors: Xiaogang Dong, Cupertino, CA (US); Yujia Chen, Redmond, WA (US); Changjung Kao, Pleasanton, CA (US)

(21) Appl. No.: 19/261,429

(22) Filed: Jul. 7, 2025

Related U.S. Application Data
(60) Provisional application No. 63/669,614, filed on Jul. 10, 2024.

(51) Int. Cl. H04N 23/90; G06F 3/01; G06F 40/58; G06K 7/14; H04N 23/61; H04N 23/66

(52) U.S. Cl. CPC H04N 23/90; G06F 3/013; H04N 23/61; H04N 23/66; G06F 40/58; G06K 7/1404

(57) ABSTRACT

A multi-camera system includes a guide camera, a plurality of detail cameras, and processing logic. The guide camera configured to capture a guide image in a first field of view (FOV). The plurality of detail cameras have narrower field of views (FOVs) than the first FOV of the guide camera. The processing logic is configured to selectively activate one or more of the detail cameras to capture one or more detail images in response to the guide image.

### CROSS-REFERENCE TO RELATED APPLICATIONS

This application claims priority to U.S. provisional Application No. 63/669,614 filed Jul. 10, 2024, which is hereby incorporated by reference.

### TECHNICAL FIELD

This disclosure relates generally to optics, and in particular to cameras.

### BACKGROUND INFORMATION

Cameras are included in many devices. Capturing photos or videos with cameras at high resolution draws significant power from the device. Transmitting high resolution images can also be a significant power draw on a device. In some contexts, only a portion of an image is required to be a high resolution image. In some contexts, images are analyzed using image processing techniques that don't require the entire image to be high resolution.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates an example head-mounted display (HMD) including a top structure, a rear securing structure, and a side structure with a viewing structure, in accordance with aspects of the disclosure.

FIG. 1B illustrates an example head-mounted device including processing logic, an eye-tracking system, one or more speakers, and optical assemblies, in accordance with aspects of the disclosure.

FIGS. 2A-2D illustrate example field of views (FOVs) of guide cameras and detail cameras, in accordance with aspects of the disclosure.

FIG. 3A illustrates a scene having zones corresponding to FOVs of detail cameras, in accordance with aspects of the disclosure.

FIG. 3B, illustrates an example foveated image that includes a detailed portion captured by a detail camera, in accordance with aspects of the disclosure.

FIG. 3C illustrates an example foveated image that includes a detailed portion captured by more than one detail camera, in accordance with aspects of the disclosure.

FIG. 4 illustrates an example multi-camera system having a guide camera, a plurality of detail cameras, and processing logic, in accordance with aspects of the disclosure.

FIG. 5A illustrates an example multi-camera system having a guide camera, a plurality of detail cameras, and processing logic that includes Artificial Intelligence (AI) processing logic, in accordance with aspects of the disclosure.

FIG. 5B illustrates that AI processing logic may be located on an external device that is remote or proximate to the device having the guide camera and detail cameras, in accordance with aspects of the disclosure.

FIG. 6 illustrates a flow chart of an example process of selectively activating detail cameras, in accordance with aspects of the disclosure.

### DETAILED DESCRIPTION

Embodiments of a multi-camera system are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Existing multi-camera systems have all cameras running full-time, which results in significant power consumption. The corresponding image signal processing (ISP) pipelines are also very complicated to process and fuse images from all cameras at the same time. For some Artificial Intelligence (AI) applications, the processing unit has to process all camera data streams. In the context of head-mounted devices such as smartglasses or Augmented Reality (AR) glasses, using multiple smaller cameras is an attraction option for form factor flexibility considerations.

In implementations of the disclosure, on-demand activation of multi-camera system may include a Region-of-Interest (ROI) Prediction Unit, an Activation Control Unit, and a Foveated View Rendering Unit. The multi-camera system may include one guide camera and multiple detail cameras. Additional input may be provided to the ROI prediction unit. Examples of such optional inputs may include gaze data and Object-Of-Interest tracking data. Audio input may also be an additional input to the ROI prediction unit. The ROI prediction unit may leverage the information from the optional inputs to determine the ROI on the guide camera frames. Based on the output of ROI prediction unit, the Activation Control Unit may then decide which one or more detail cameras to capture and transmit image data. A Foveated View Rendering Unit may fuse the guide camera frame and one or more detail camera frames together to generate a foveated image, where the ROI is rendered with high resolution details and lower resolution frame from the guide camera is used elsewhere.

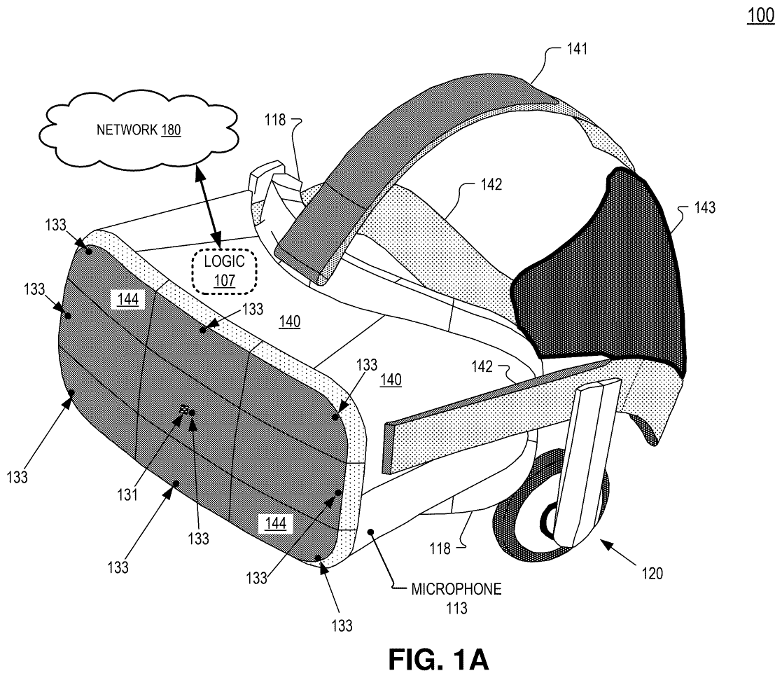

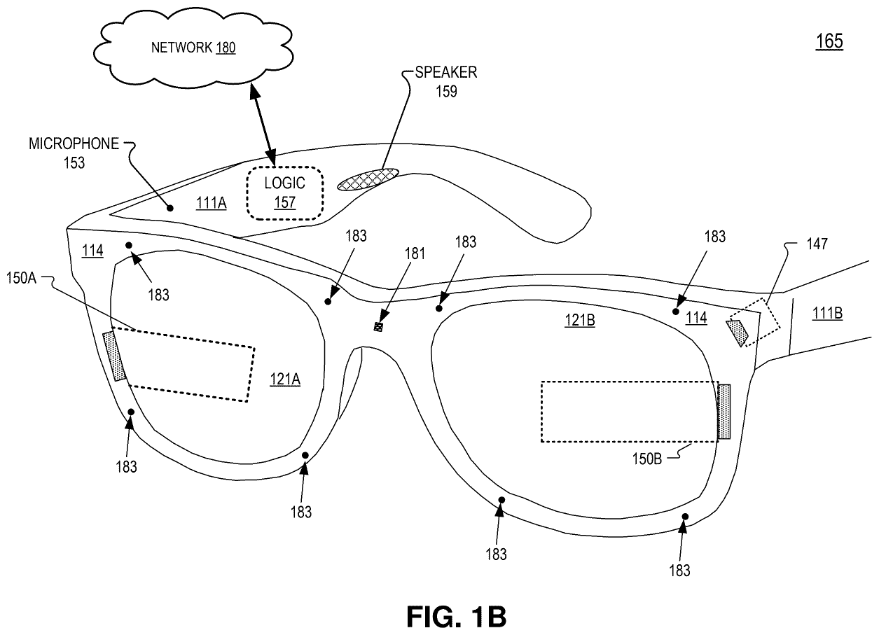

In implementations of the disclosure, on-demand activation of multi-camera system can also be adopted for AI applications. In this case, the activation control unit selects the most appropriate one or more detail cameras and feeds the corresponding data to AI Application processing logic. The AI applications include, but are not limited to, text/barcode/object recognition, scene understanding, and action analysis. These and other embodiments are described in more detail in connections with FIGS. 1A-6.

FIG. 1A illustrates an example head mounted display (HMD) 100 including a top structure 141, a rear securing structure 143, and a side structure 142 attached with a viewing structure 140, in accordance with implementations of the disclosure. The illustrated HMD 100 is configured to be worn on a head of a user of the HMD. In one implementation, top structure 141 includes a fabric strap that may include elastic. Side structure 142 and rear securing structure 143 may include a fabric as well as rigid structures (e.g. plastics) for securing the HMD to the head of the user. HMD 100 may optionally include earpiece(s) 120 including speakers configured to deliver audio to the ear(s) of a wearer of HMD 100.

In the illustrated embodiment, viewing structure 140 includes an interface membrane 118 for contacting a face of a wearer of HMD 100. Interface membrane 118 may function to block out some or all ambient light from reaching the eyes of the wearer of HMD 100. Viewing structure 140 may include a display side 144 that is proximate to a display panel that generates virtual images for presenting to an eye of a user of HMD 100.

Example HMD 100 also includes a chassis for supporting hardware of the viewing structure 140 of HMD 100. Hardware of viewing structure 140 may include any of processing logic, wired and/or wireless data interface for sending and receiving data, graphic processors, and one or more memories for storing data and computer-executable instructions. In one implementation, viewing structure 140 may be configured to receive wired power. In one implementation, viewing structure 140 is configured to be powered by one or more batteries. In one implementation, viewing structure 140 may be configured to receive wired data including video data. In one implementation, viewing structure 140 is configured to receive wireless data including video data.

Viewing structure 140 may include processing logic 107 and processing logic may be connected to transmit and receive data from a network 180 that may be local or remote. HMD 100 includes a microphone 113 configured to record audio inputs. Microphone 113 may be configured to receive voice inputs from a user of HMD 100 and provide the voice inputs to processing logic 107. HMD 100 includes a guide camera 131 and a plurality of detail cameras 133. In the illustrated implementation, the detail cameras 133 are arranged in (roughly) a 3×3 grid. In other implementations, the detail cameras may be arranged in 2×2 grids, 2×3 grids, 3×2 grids, other grids, other geometric arrangements, or freeform placement of the detail cameras. While an HMD is illustrated in FIG. 1A, the disclosed multi-camera system may be implemented in other devices including other wearables such as augmented reality (AR) glasses and smartglasses.

FIG. 1B illustrates an example head-mounted device 165 including processing logic 157, eye-tracking system 147, speaker 159, and optical assemblies 121A/B, in accordance with aspects of the disclosure. Head-mounted device 165 may be smartglasses or AR glasses, for example. Head-mounted device 165 is illustrated as AR glasses since optical assemblies 121A and 121B include display waveguides 150A and 150B to present virtual images to an eyebox region. Head-mounted device 165 includes arms 111A/B connected to frame 114 that holds the optical assemblies 121A and 121B (collectively referred to as optical assemblies 121). In some implementations, head-mounted device 165 includes display technology that is different than utilizing waveguide 150A and 150B (collectively referred to as waveguides 150). FIG. 1B shows example placements of a 2×4 grid of detail cameras 183 and a guide camera 181. Of course, other grid patterns of different geometries are contemplated.

Eye-tracking system 147 may be configured to generate eye-tracking data. The eye-tracking data may include a position of an eye of a user that resides in an eyebox region of head-mounted device 165. Gaze data may be generated from the eye-tracking data. For example, if the position of the eye is resting in a particular location for a threshold amount of time, the direction of the gaze of the user can be calculated from the position of the eye to generate the gaze data. The eye-tracking data and gaze data may be generated by imaging the eye(s) of user residing in the eyebox region. The eye-tracking data and gaze data may be generated by using one or more eye-tracking cameras. In some implementations, other imaging modalities (e.g. radar or ultrasound) are used to generate eye-tracking data. While FIG. 1B illustrates an eye-tracking system 147 for imaging only one eyebox region, it is understood that more than one eye-tracking system may be implemented in head-mounted device 165 in order to generate eye-tracking data for both eyes of the user, in some implementations. Gaze data may be generated from eye-tracking data from both eyes, in some implementations.

FIG. 1B illustrates a speaker 159 included in arm 111A. More than one speaker may be included in head-mounted device 165. While not particularly illustrated, one or more speakers may be included in arm 111B. The speakers may be oriented to direct sound waves toward ears of a user while a user is wearing head-mounted device 165. Processing logic 157 may be configured to drive audio signals onto the speaker(s) to generate the sound waves.

Head-mounted device 165 includes a microphone 153 configured to record sound. Microphone 153 may be configured to receive voice inputs from a user of head-mounted device 165 and provide the voice inputs to processing logic 157. Head-mounted device may include an array of microphones.

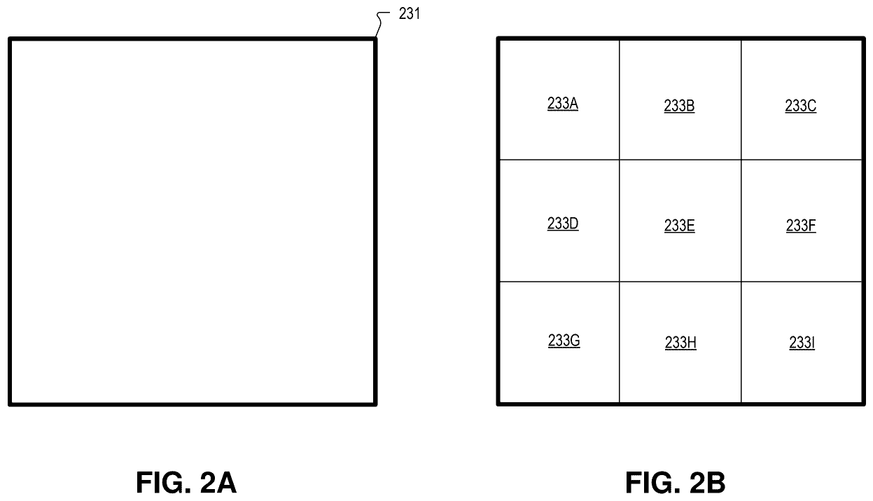

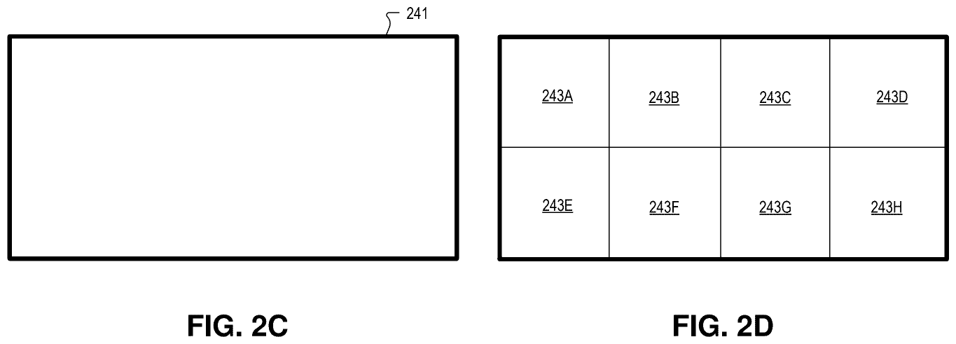

FIG. 2A illustrates a field of view (FOV) 231 of guide camera 131 and FIG. 2B illustrates narrower field of views (FOVs) 233A-2331 of detail cameras 133. The narrower FOVs 233A-233I may combine to image the same or greater than the FOV 231. In some implementations, each narrow FOV 233 overlaps (slightly) the FOV of an adjacent or diagonal detail camera. Thus, FOV 233A may overlap (slightly) FOVs 233B, 233D, and 233E. FOV 233E may slightly overlap FOVs 233A, 223B, 223C, 233D, 233F, 233G, 233H, and 233I, for example. The guide camera 131 may have a lower resolution than detail cameras 133. In some implementations, the guide camera 131 has the same resolution as the detail cameras 133. The detail cameras 133 have a higher resolution for a same FOV compared to guide camera 131 and thus the detail images captured by the detail cameras have a higher resolution than the guide image for the same FOV. In some implementations, the narrower FOVs of the detail cameras overlap at least three of the other detail cameras in the plurality of detail cameras. The cameras in the disclosure may be configured to image visible light and/or infrared light. The cameras may include Complementary metal-oxide-semiconductor (CMOS) image sensors.

FIG. 2C illustrates a field of view (FOV) 241 of guide camera 181 and FIG. 2D illustrates narrower field of views (FOVs) 243A-243H of detail cameras 183. The narrower FOVs 243A-243H may combine to image the same or greater than the FOV 241. In some implementations, each narrow FOV 243 overlaps (slightly) the FOV of an adjacent or diagonal detail camera. Thus, FOV 243A may overlap (slightly) FOVs 243B, 243E, and 243F. FOV 243C may slightly overlap FOVs 243B, 243D, 243F, 243G, and 243H, for example. The guide camera 181 may have a lower resolution than detail cameras 183. The guide camera 181 may have a same resolution as the detail cameras 183. The detail cameras 183 have a higher resolution for a same FOV compared to guide camera 181 and thus the detail images captured by the detail cameras have a higher resolution than the guide image for the same FOV. In some implementations, the narrower FOVs of the detail cameras overlap at least three of the other detail cameras in the plurality of detail cameras.

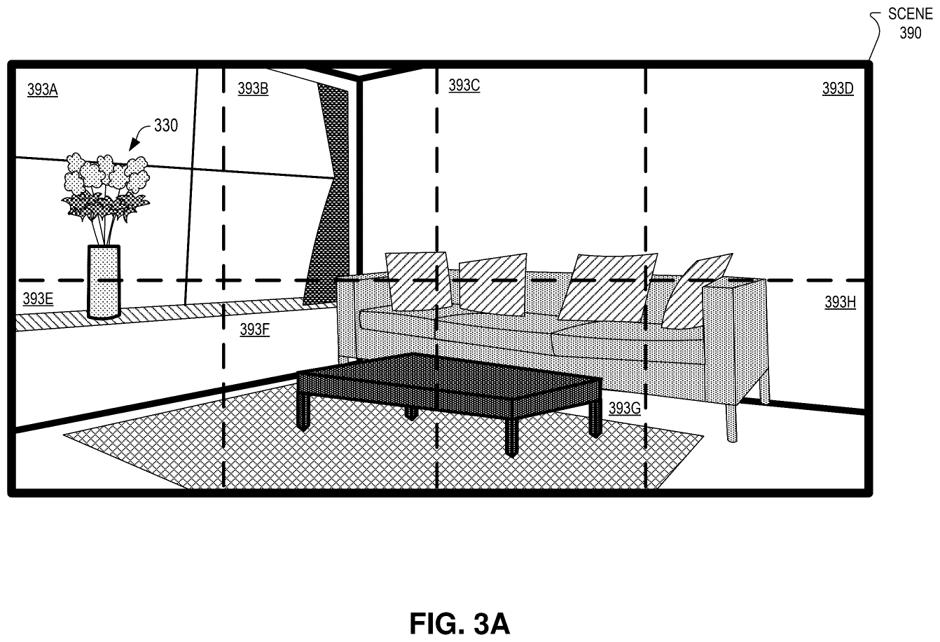

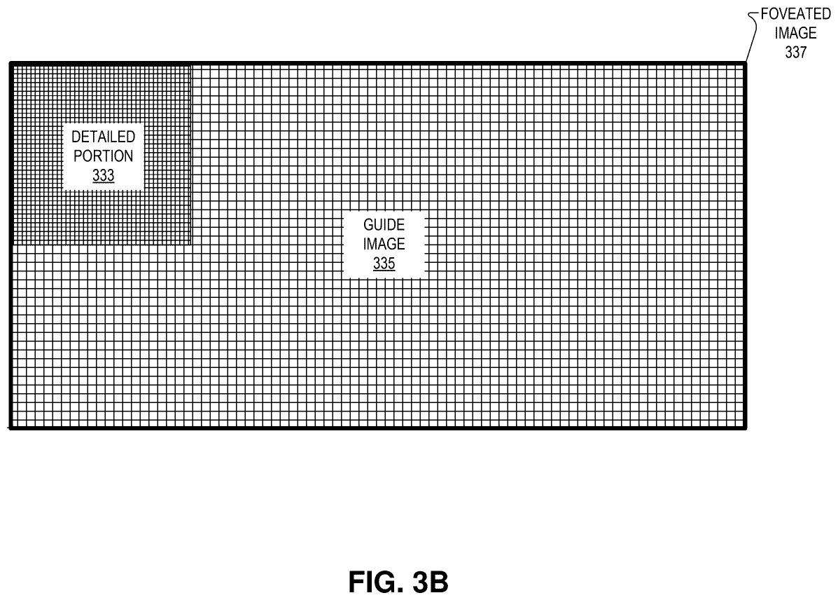

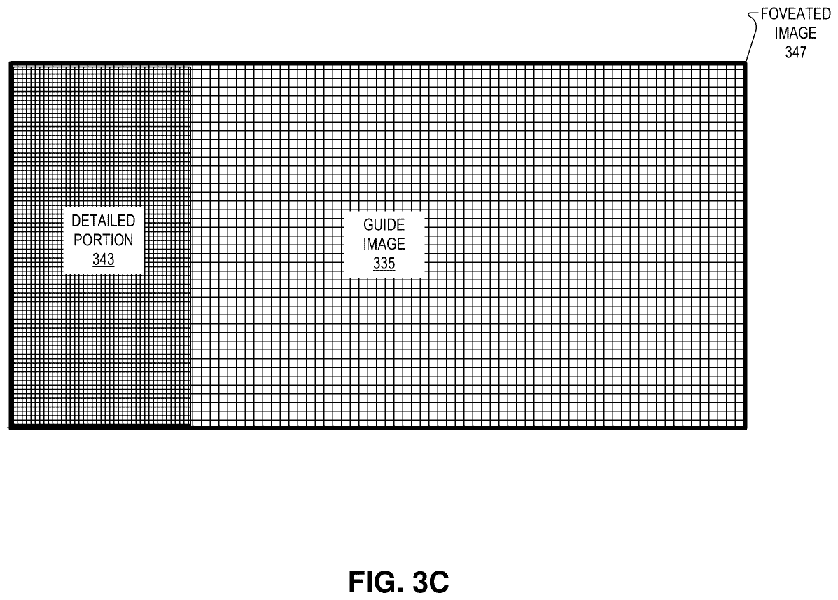

FIG. 3A illustrates a scene 390 having zones, in accordance with aspects of the disclosure. Scene 390 includes zones 393A, 393B, 393C, 393D, 393E, 393F, 393G, and 393H (collectively referred to as zones 393). Each zone may correspond to a FOV of a detail camera, for example. Scene 390 includes a plant 330 that may be an object of interest in the scene 390. Hence, it may be desirable to capture a higher resolution image of plant 330 to assist in identifying the plant 330 while the remainder of scene 390 (e.g. zones 393B, 393C, 393D, 393E, 393F, 393G, 393G, and 393H) don't necessarily require a high resolution image to identify plant 330.

FIG. 3B illustrates an example foveated image 337 that includes a detailed portion 333 captured by a detail camera that is added to a guide image captured by a guide camera, in accordance with aspects of the disclosure. To generate foveated image 337, one of the detail cameras that is configured to image zone 393A (having a FOV that includes zone 393A) may be activated to capture a higher resolution image of zone 393A. This detail image may be added to a guide image 335 so that the plant 330 in zone 393A is captured in high resolution while the guide image 335 can still give some context (e.g. indoor scene) as to the rest of the scene 390.

In some implementation, plant 330 may occupy multiple zones 393. FIG. 3C illustrates an example foveated image 343 that includes a detailed portion 343 captured by more than one detail camera, in accordance with aspects of the disclosure. Detailed portion 343 is added to a guide image captured by a guide camera. To generate foveated image 347, the detail cameras that are configured to image zones 393A and 393E may be activated to capture higher resolution images of zones 393A and 393E. These two detail images may be added to a guide image 335 as detailed portion 343 so that the plant 330 in zones 393A and 393E is captured in high resolution while the guide image 335 can still give some context as to the rest of the scene 390. In other implementations of the disclosure, foveated images may include detail images from more than two detail cameras. For example, if plant 330 occupied three zones 393, three detail cameras may be activated to captured higher resolution detail images of plant 330 that can be added to a guide image to generate a foveated image.

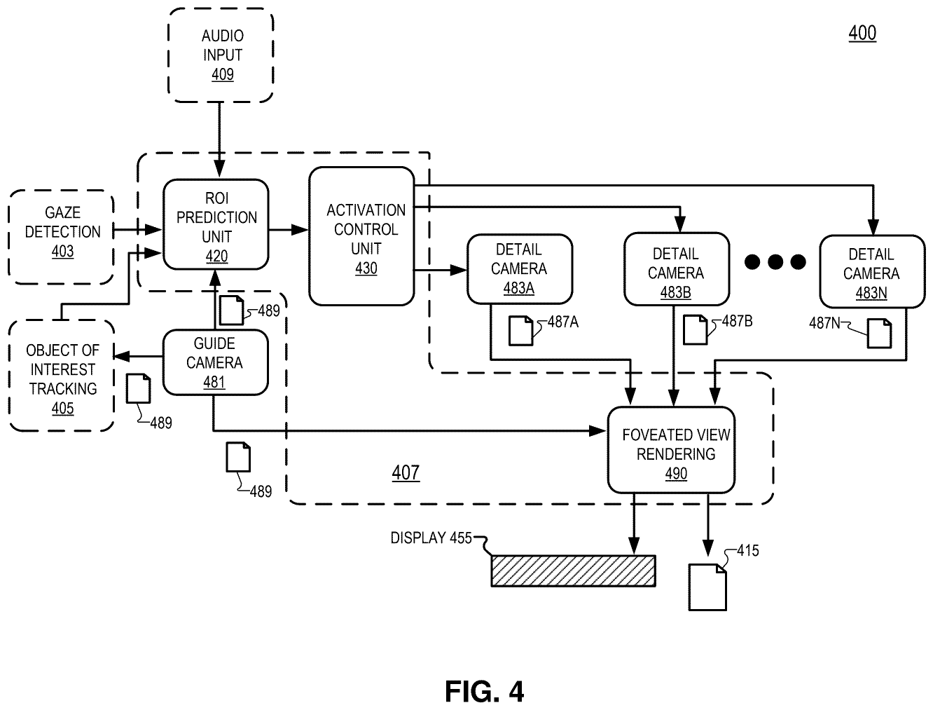

FIG. 4 illustrates an example multi-camera system 400 having a guide camera 481, a plurality of detail cameras 483A, 483B . . . 483N, and processing logic 407, in accordance with aspects of the disclosure. Processing logic 407 may include a Region of Interest (ROI) prediction unit 420, an activation control unit 430, and Foveated View Rendering Module 490. Multi-camera system 400 may be included in a device such as HMD 100 or head-mounted device 165, for example.

ROI prediction unit 420 is configured to predict an ROI of a guide image 489 generated by guide camera 481. It may leverage additional inputs to determine the ROI in guide image 489, for example, gaze data or pre-selected objects of interest or tracked object of interest. The gaze data may be derived from or received from an eye-tracking module of a head-mounted device. Gaze data may be provided to ROI prediction unit 420 by gaze detection logic 403, for example. The eye-tracking module may include sensors that image an eyebox region that includes an eye. ROI prediction unit 420 may also predict an ROI of guide image 489 based at least in part on an audio recording input.

Object of interest tracking (OOIT) logic 405 is configured to receive guide image 489 from guide camera 481. OOIT logic 405 may perform image processing on guide image(s) 489 to determine an object of interest based on movement in the image or based on pre-selected objects of interest. In an example illustration, a basketball in a basketball game is identified as an object of interest based on the movement of the basketball in guide images 489. In an example illustration, an animal traveling through the frame is identified as an object of interest based on the movement of the animal in guide images 489. In another example, a face of a person is identified as an object of interest in the guide image 489. In one implementation, a plant is identified as an object of interest in the guide image 489. In one implementation, a barcode is identified as an object of interest in the guide image 489. In one implementation, text is identified as an object of interest in the guide image 489. OOIT logic 405 is configured to provide object of interest tracking (OOIT) data to processing logic 407, in FIG. 4. OOIT logic 405 may be configured to provide OOIT data to ROI prediction unit 420 of processing logic 407, in some implementations.

Gaze detection logic 403 generates gaze data in response to receiving eye-tracking data generated from an eye-tracking module. Gaze data may be generated from the eye-tracking data. For example, if the position of the eye is resting in a particular location for a threshold amount of time, the direction of the gaze of the user can be calculated from the position of the eye to generate the gaze detection data. The eye-tracking data and gaze detection data may be generated by imaging the eye of user residing in the eyebox region. The eye-tracking data and gaze detection data may be generated by using one or more eye-tracking cameras. In some implementations, other imaging modalities (e.g. radar or ultrasound) are used to generate eye-tracking data. Gaze detection logic 403 is configured to provide gaze data to ROI prediction unit 420, in FIG. 4. Gaze detection logic 403 may be configured to provide gaze data to ROI prediction unit 420 of processing logic 407, in some implementations.

System 400 includes an audio input module 409 that may receive inputs from a microphone (e.g. microphone 113 or 153). Audio input module 409 is configured to provide an audio recording input to processing logic 407, in FIG. 4. Processing logic 407 may identify the ROI of the guide image 489 based at least in part on the audio recording input. Audio input module 409 may be configured to provide an audio recording input to ROI prediction unit 420 of processing logic 407, in some implementations. An audio recording input may be received by ROI prediction unit 420 and ROI prediction unit 420 may identify the ROI of the guide image 489 based at least in part on the audio recording input.

The activation control unit 430 may selectively activate one or more detail cameras in the plurality based on the input of ROI prediction unit 420. System 400 includes a plurality of detail cameras 483A, 483B . . . 483N, where N is any integer number. The plurality of detail cameras 483A-483N may be collectively referred to as detail cameras 483. Depending on which detail cameras 483 are activated, the activated cameras will generate detail images 487A, 487B . . . 487N that correspond with the respective detail camera, as illustrated in FIG. 4. The plurality of detail images 487A-487N may be collectively referred to as detail images 487. In some examples, a single detail camera is activated and a single detail image 487 is captured by the activated detail camera. In this case, Foveated View Rendering module 490 receives the single detail image. In some examples, more than one detail camera is activated to capture more than one detail image of the ROI identified by ROI prediction unit 420. In this example, more than one detail camera is activated and more than one detail image is captured by the activated detail cameras. The detail cameras may be driven by activation control unit 430 to capture the detail images at the same time (or at approximately the same time). In this case, Foveated View Rendering module 490 receives the detail images captured contemporaneously (or approximately contemporaneously).

Foveated View Rendering module 490 is also configured to receive the guide image from guide camera 481, in the example illustrated in FIG. 4. Foveated View Rendering module 490 may fuse the guide image 489 and one or more detail images 487 together to generate a foveated image 415, where the ROI identified by ROI prediction unit 420 is rendered with high resolution details and a lower resolution frame from the guide image is used in the remainder of the foveated image 415. For example, foveated image 337 of FIG. 3B includes a higher resolution detailed portion 333 provided by a detail image 487 captured by a detail camera. Foveated image 337 may be an example of foveated image 415. In another example, foveated image 347 of FIG. 3C includes a higher resolution detailed portion 343 provided by two detail images 487 captured by two detail cameras that were activated. Foveated image 347 may be an example of foveated image 415. By activating the needed detail cameras only for the portions of the scene that high-resolution imaging is desired, it saves a significant amount of power and reduces the image processing requirements.

Therefore, processing logic 407 may selectively activate one or more of the detail cameras 483 to capture detail images 487 and generate a foveated image 415 from the detail images 487 and the guide image 489. Detail portions of the foveated image 415 have a higher resolution than the guide image 489. Detailed portions of foveated image 415 are generated from the detail image(s) 487.

In an example illustration, processing logic 407 may receive gaze data from the gaze detection logic 403 indicating that a user is gazing straight ahead (or predicting that the user may soon be gazing straight ahead). Using the FOVs of FIG. 2B as an example, processing logic 407 may activate the detailed camera having FOV 233E, which is a FOV in the middle of the FOV 231 of the guide camera 481. Of course, the FOVs illustrated in FIG. 2D (or other FOVs corresponding to different arrangements of detail cameras) may also be utilized, in aspects of the disclosure. Foveated view rendering module 490 may then receive the guide image from guide camera 481 and receive a detail image from the activated detail camera 483 that is configured to image FOV 233E. In FIG. 1A, the detail camera having a FOV 233E may be detail camera 133 that is located next to guide camera 131, for example. Foveated image 415 may then include the guide image 489 with the middle portion of the guide image being augmented by the detail image 487 from the detail camera that images FOV 233E. The foveated image 415 may be stored to a memory of a wearable device. In some implementations, foveated image 415 is transmitted from a head-mounted device to an external device such as a computing puck, smartphone, tablet, computer, or cloud computing.

In some implementations, the foveated image 415 (or some derivation thereof) generated by foveated view rendering module 490 is used as a passthrough image that is presented to a user of a head-mounted display. Since the user is gazing directly ahead, the portion of the image that is being gazed upon may be the more important portion of the image to provide more details (e.g. higher resolution). The passthrough image may be driven onto a display 455 of a head-mounted display such as HMD 100. The passthrough image may support Mixed Reality (MR) features of HMD 100, in some contexts.

In another example illustration, processing logic 407 is configured to selectively activate the one or more detail cameras 483 to capture detail images 487 in response to object of interest tracking data received from the OOIT logic 405. Objects of interest may be virtual objects or objects/person/animal in the real-world objects. OOIT logic 405 may receive the guide image 489 from guide camera 481 to assist in determining a real-world object of interest. Machine Learning (ML), or Artificial Intelligence (AI) processes may be used to determine real-world objects of interest. Real-world objects of interest may be determined by motion analysis of a sequence of guide images, in some implementations.

ROI prediction unit 420 may receive inputs from the gaze detection logic 403, OOIT logic 405, and/or audio input module 409. Activation control unit 430 activates the detail cameras 483 based on input from ROI prediction unit 420, in the illustration of FIG. 4. One or more detail cameras 483 may be activated simultaneously by the activation control unit 430.

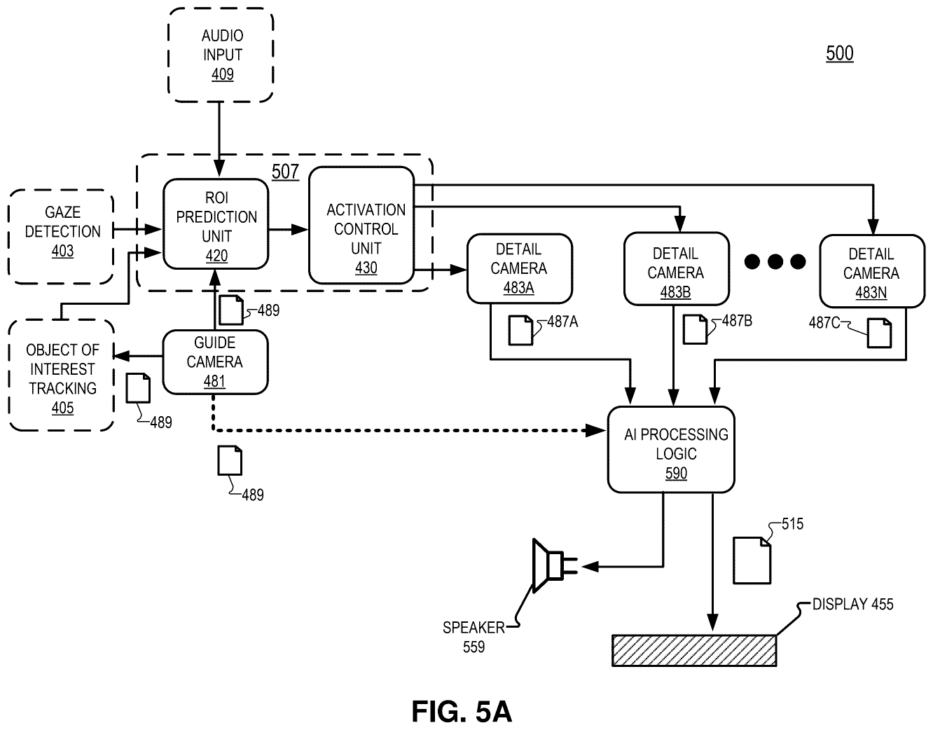

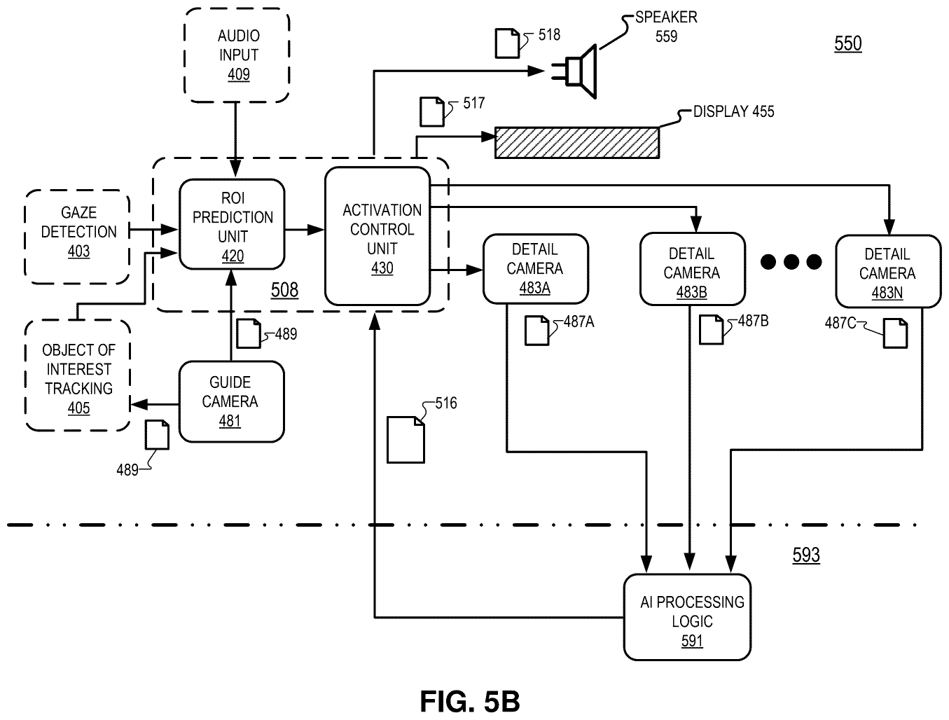

FIG. 5A illustrates an example multi-camera system 500 having a guide camera, a plurality of detail cameras 483A, 483B . . . 483N, and processing logic 507 that includes an Artificial Intelligence (AI) processing logic 590, in accordance with aspects of the disclosure. The on-demand activation of the multi-camera system 500 can be used in an AI context.

In an implementation, processing logic 507 is configured to selectively activate one or more of the detail cameras 483 to capture one or more detail images 487 in response to the guide image 489 captured by guide camera 481. The detail images that are captured are transmitted to AI processing logic 590. Limiting the data to be processed by AI processing logic 590 (by only sending it the detail image(s) 487 associated with the Region of Interest of the guide image 489) reduces the power and compute resources that are utilized compared to processing a high-resolution guide image that includes the entire FOV of a guide image. Additionally, latency associated with processing larger images is reduced. Only transmitting the selected detail images to AI processing logic 590 may also save on power and latency associated with the transmission of larger images.

In an implementation, processing logic 507 is configured to selectively activate the one or more of the detail cameras 483 to capture the one or more detail images 487 in response to a gaze data of an eye provided by gaze detection logic 403. In an implementation, processing logic 507 is configured to selectively activate the one or more of the detail cameras 483 to capture the one or more detail images 487 in response to object of interest tracking data derived from guide image 489. OOIT logic 405 may generate the OOIT data after receiving guide image 489 from guide camera 481. In some implementations, one or more detail images 487 are transferred via a wireless communication channel to AI processing logic 590.

AI processing logic 590 may be configured to generate outputs based on receiving one or more detail images 487. In FIG. 5A, system 500 includes one or more speakers 559 and a display 455. AI processing logic 590 may generate an audio output that is driven onto the one or more speakers 559. The one or more speakers 559 may be configured to provide audio in a wearable. AI processing logic 590 may generate an image that is rendered to display 455. Display 455 may be included as a display in a head-mounted display, in some implementations.

In an example illustration that utilizes system 500, a user gazing at a restaurant menu in a different language may be interested in a particular menu item. The menu item may be identified by ROI prediction unit 420 from inputs such as gaze detection data and/or an audio recording input (e.g. user saying “please translate” as they look at the menu item they desire to translate). ROI prediction unit 420 may identify the ROI in guide image 489 that includes the menu item and one or more detail cameras may then be activated to take a more detailed image 487 of that menu item so that the text from the different language can be translated for the user, by providing the detailed image(s) 487 that includes the menu item to AI processing logic 590. The translation of the menu item may be provided by AI processing logic 590 in the form of an audio output that can be driven onto speaker(s) 559 to the ears of the user. The translation of the menu item may be provided by AI processing logic 590 in the form of text or an image 515 that can be rendered to a display 455 of an HMD.

In another example, a user may desire to know more information about a barcode that the user is looking at. The barcode may be one-dimensional or two-dimensional. The barcode may be identified by ROI prediction unit 420 from inputs such as gaze detection data and/or an audio recording input (e.g. user saying “tell me more about the barcode” as they look at the barcode they desire to know more about). OOIT logic 405 may also provide OOIT data to ROI prediction unit 420. ROI prediction unit 420 may identify the ROI in guide image 489 that includes the barcode and one or more detail cameras may then be activated to take a more detailed image 487 of the barcode so that more information can be provided to the user, by providing the detailed image(s) 487 that includes the barcode to AI processing logic 590. A description of the barcode or a website that the barcode points to may be provided by AI processing logic 590 in the form of an audio output that can be driven onto speaker(s) 559 to the ears of the user. The description of the barcode or a website that the barcode points to may be provided by AI processing logic 590 in the form of text or an image 515 that can be rendered to a display 455 of an HMD. In some implementations, a website that the barcode points to is rendered as image 515 driven onto a display 455 of an HMD.

In an example illustration that utilizes system 500, a user gazes at a living object such as a particular plant and desires to know more about the plant. The plant may be identified by ROI prediction unit 420 from inputs such as gaze detection data and/or an audio recording input (e.g. user saying “tell me more about this plant” as they look at the plant they desire to know more about). ROI prediction unit 420 may identify the ROI in guide image 489 that includes the plant and one or more detail cameras may then be activated to take a more detailed image 487 of the plant. The detail image(s) 487 may be by provided to AI processing logic 590. A name and/or description of the plant may be provided by AI processing logic 590 in the form of an audio output that can be driven onto speaker(s) 559 to the ears of the user. The name and/or description of the plant may be provided by AI processing logic 590 in the form of text or an image 515 that can be rendered to a display 455 of an HMD. Other living objects may be identified and described in a similar way.

Non-living objects may also be identified and described in similar ways. For example, the part number or model number for a car part, a faucet, a shoe, and/or a garment may be provided or described similarly. This functionality may be considered object recognition. Scene understanding and action analysis may be performed by AI processing logic 590, in some implementations. In the illustrated example of FIG. 5A, AI processing logic 590 may be located on a same device as the guide camera 481 and detail cameras 483. In some implementations, guide image 489 is provided to AI processing logic 590 to provide additional (lower resolution) context in addition to the higher resolution detail image(s) 487.

FIG. 5B illustrates that AI processing logic 591 may be located on an external device (e.g. computer, smartphone, tablet, or computing puck) that is proximate to the device having the guide camera and detail cameras, in accordance with aspects of the disclosure. In some examples, AI process logic 591 is located remotely (e.g. a cloud computing data center) from the device having the guide camera and detail cameras. In the example illustration of FIG. 1, device 100 may send the detail images to different devices or a data center by wirelessly transmitting the detail images over a network 180 that may be wired or wireless.

FIG. 5B shows AI process logic 591 included in an external device 593, in accordance with aspects of the disclosure. In this implementation, detail image(s) 487 may be wirelessly transmitted to AI processing logic 591 on external device 593. External device 593 may have more power and/or compute resources than device 550, especially when device 550 is a wearable such as a head-mounted device. Device 550 includes processing logic 508, guide camera 481, and detail cameras 483. Device 550 also optionally includes audio input module 409, gaze detection logic 403, and OOIT logic 405. Device 550 may include speaker(s) 559. Device 550 may include display 455 when device 550 is a head-mounted display.

AI processing logic 591 may be configured to generate return data 516 in response to receiving detail image(s) 487 captured by detail cameras 483. Processing logic 508 may receive return data 516 from AI processing logic 591. In some implementations, return data 516 includes an audio output and processing logic 508 may drive the audio output on to speaker(s) 559. For example, an audio output of a translation of text or a name of a plant may be driven onto speaker 559. Other audio outputs recited in examples described above may be included as the audio output. In some implementations, return data 516 includes text or an image and processing logic 508 may render the text of image to display 455. For example, text of a translation or a name of a plant may be rendered to display 455. Other text or images recited in examples recited above may be included as the return data and driven onto display 455.

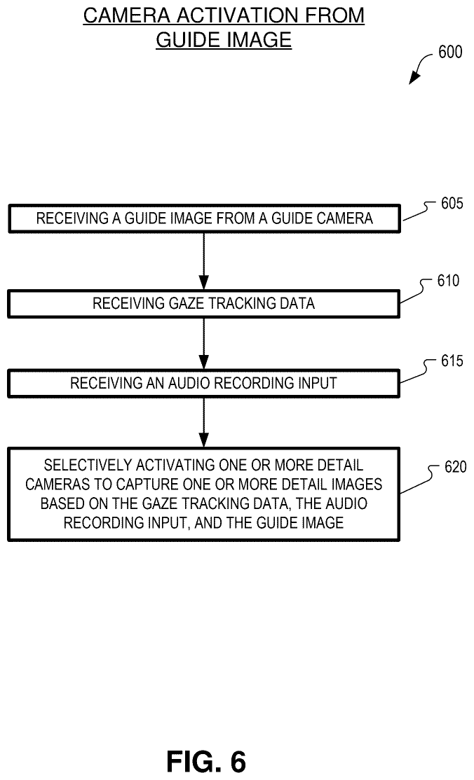

FIG. 6 illustrates a flow chart of an example process 600 of selectively activating detail cameras, in accordance with aspects of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel.

In process block 605, a guide image is received from a guide camera of a head-mounted device configured to image a first field of view (FOV). The head-mounted device may be smartglasses or AR glasses, for example.

In process block 610, gaze tracking data is received. The gaze tracking data is generated by imaging an eyebox region of the head-mounted device.

In process block 615, an audio recording input is received. The audio recording input is generated from a microphone of the head-mounted device.

In process block 620, one or more detail cameras of the head-mounted device are selectively activated to capture one or more detail images based on the gaze tracking data, the audio recording input, and the guide image. The detail cameras have narrower field of views (FOVs) than the first FOV of the guide camera.

In implementations, process 600 further includes identifying a region of interest (ROI) of the guide image based on the gaze tracking data and the audio recording input and the detail cameras that are selectively activated are configured to image the ROI.

In implementations, process 600 further includes transmitting the one or more detailed images from the detail cameras to Artificial Intelligence (AI) processing logic and receiving return data from the AI processing logic. The return data is responsive to the detailed images. The one or more detailed images may include a living (e.g. plant or animal) or non-living object. The return data may include one or more characteristics of the living or non-living object. The return data may include a name of the living or non-living object. In an implementation, the one or more characteristics (or name) of the living or non-living object is presented to a user of the head-mounted device by driving an audio output on a speaker of the head-mounted device. In an implementation, the one or more characteristics (or name) of the living or non-living object is presented to a user of the head-mounted device by driving a responsive image onto a display of the head-mounted device. The responsive image may be generated by an AI processing unit in response to receiving detailed images. The one or more detailed images includes writing in a first language and the responsive image includes a translation of the writing in a second language different from the first language, in an implementation. The one or more detailed images includes a barcode and the responsive image includes a rendering of website encoded in the barcode, in an implementation.

In some implementations of process 600, the AI processing logic is external to the head-mounted device and the one or more detailed images are wirelessly transmitted to the AI processing logic.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A multi-camera system comprising:
a guide camera configured to capture a guide image in a first field of view (FOV);
a plurality of detail cameras having narrower field of views (FOVs) than the first FOV of the guide camera, wherein the narrower FOVs of the detail cameras overlap the first FOV of the guide camera; and
processing logic configured to selectively activate one or more of the detail cameras to capture one or more detail images in response to the guide image, wherein the detail images are transmitted to artificial intelligence (AI) processing logic.

2. The multi-camera system of claim 1, wherein the one or more detail images include text or a barcode.

3. The multi-camera system of claim 1, wherein the processing logic is configured to selectively activate the one or more of the detail cameras to capture the one or more detail images in response to gaze data of an eye.

4. The multi-camera system of claim 1, wherein the processing logic is configured to selectively activate the one or more of the detail cameras to capture the one or more detail images in response to object of interest tracking data derived from the guide image.

5. The multi-camera system of claim 1, wherein the one or more detail images are transferred via a wireless communication channel to the AI processing logic.

6. The multi-camera system of claim 1, wherein the narrower FOVs of the detail cameras combine to include the first field of view of the guide camera.

7. The multi-camera system of claim 1, wherein the one or more detail images have a higher resolution than the guide image for a same FOV.

8. The multi-camera system of claim 1, wherein the narrower FOVs of the detail cameras overlap other detail cameras in the plurality of detail cameras.

9. The multi-camera system of claim 1 further comprising:
a speaker, wherein the processing logic is further configured to:
receive return data from the AI processing logic, wherein the return data is responsive to the detailed images; and
drive an audio output on the speaker in response to the return data.

10. A head mounted display comprising:
a display for rendering images to an eyebox region;
a guide camera configured to capture a guide image in a first field of view (FOV);
a plurality of detail cameras having narrower field of views (FOVs) than the first FOV of the guide camera, wherein the narrower FOVs of the detail cameras overlap the first FOV of the guide camera;
processing logic configured to:
selectively activate one or more of the detail cameras to capture one or more detail images;
generate a foveated image from the detail images and the guide images, detailed portions of the foveated image having higher resolution than the guide image, wherein the detailed portions of the guide image are generated from the detail images; and
render display images to the display, wherein the display images include at least a portion of the foveated image.

11. A method comprising:
receiving a guide image from a guide camera of a head-mounted device configured to image a first field of view (FOV);
receiving gaze data by imaging an eyebox region of the head-mounted device;
receiving an audio recording input from a microphone of the head-mounted device; and
selectively activating one or more detail cameras of the head-mounted device to capture one or more detail images based on the gaze data, the audio recording input, and the guide image, wherein the detail cameras have narrower field of views (FOVs) than the first FOV of the guide camera.

12. The method of claim 11 further comprising:
identifying a region of interest (ROI) of the guide image based on the gaze data and the audio recording input, wherein the detail cameras selectively activated are configured to image the ROI.

13. The method of claim 11 further comprising:
transmitting the one or more detailed images from the detail cameras to an Artificial Intelligence (AI) processing logic; and
receiving return data from the AI processing logic, where the return data is responsive to the detailed images.

14. The method of claim 13, wherein the one or more detailed images include a living or non-living object, and wherein the return data includes one or more characteristics of the living or non-living object.

15. The method of claim 14, further comprising:
presenting the one or more characteristics of the living or non-living object to a user of the head-mounted device by driving an audio output on a speaker of the head-mounted device.

16. The method of claim 14, further comprising:
presenting the one or more characteristics of the living or non-living object to a user of the head-mounted device by driving a responsive image onto a display of the head-mounted device.

17. The method of claim 16, wherein the one or more detailed images includes writing in a first language, and wherein the responsive image includes a translation of the writing in a second language different from the first language.

18. The method of claim 16, wherein the one or more detailed images includes a barcode, and wherein the responsive image includes a rendering of website encoded in the barcode.

19. The method of claim 13, wherein the AI processing logic is external to the head-mounted device, and wherein the one or more detailed images are wirelessly transmitted to the AI processing logic.

20. The method of claim 11, wherein the narrower FOVs of the detail cameras overlap the first FOV of the guide camera.
